(19) United States
(12) Patent Application Publication
(10) Pub. No.: US 2019/0139090 A1
(43) Pub. Date: May 9, 2019

(54) MARKETING NOTIFICATION FOR MISSING GROUP MEMBER

(71) Applicant: International Business Machines Corporation, Armonk, NY (US)

(72) Inventors: Jeremy A. Greenberger, San Jose, CA (US); Steve McDuff, Markham (CA)

(21) Appl. No.: 15/802,609

(22) Filed: Nov. 3, 2017

(51) Int. Cl. G06Q 30/02; H04W 68/00; H04M 3/42

(52) U.S. Cl. CPC G06Q 30/0261; G06Q 30/0201; G06Q 30/0281; H04M 3/42348; H04W 68/005

(57) ABSTRACT

Disclosed embodiments provide techniques for presenting a marketing notification for a missing member of a group. People often shop in groups, such as groups of family, friends, coworkers, and the like. Disclosed embodiments detect the presence of a group in a location such as a retail venue. In scenarios where at least one member of the group is absent at the location, the group members that are present at the location receive a marketing message pertaining to the missing member, such as a suggestion to purchase a gift for the missing member. In this way, disclosed embodiments provide marketing opportunities to influence shoppers by reminding them about their missing peer.

### FIELD OF INVENTION

Embodiments of the invention relate to electronic marketing systems and methods, and more particularly to systems and methods of generating a marketing notification for a missing group member.

### BACKGROUND

There are so many options today when users shop in stores and malls that sometimes it can be difficult for the consumer to sort through it all. In terms of gifts for others, a consumer may not notice a particular item he/she encounters would be appropriate for a particular friend or family member. A person may not know that the item is on sale—The sign might be down, or the person may just overlook it, while distracted searching through the store. There exists a need for improvements in marketing and advertising to consumers.

### SUMMARY

In one aspect, there is provided a computer-implemented method of sending a notification pertaining to a missing member of a group, the method comprising: identifying a plurality of members of the group at a location; identifying a missing member of the group based on one or more missing member conditions; computing a relevancy level for the missing member for an item associated with the location; responsive to computing a relevancy level above a predetermined threshold, generating a notification for the plurality of members of the group at the location, wherein the notification contains information pertaining to the missing member; and sending the notification to a first electronic computing device associated with a member from the plurality of members of the group at the location.

In another aspect, there is provided an electronic communication device comprising: a processor; a memory coupled to the processor, the memory containing instructions, that when executed by the processor, perform the steps of: identifying a plurality of members of a group at a location; identifying a missing member of the group based on one or more missing member conditions; computing a relevancy level for the missing member for an item associated with the location; responsive to computing a relevancy level above a predetermined threshold, generating a notification for the plurality of members of the group at the location, wherein the notification contains information pertaining to the missing member; and sending the notification to a first mobile device associated with a member from the plurality of members of the group at the location.

In yet another aspect, there is provided a computer program product for sending a notification pertaining to a missing member of a group, for an electronic computing device comprising a computer readable storage medium having program instructions embodied therewith, the program instructions executable by a processor to cause the electronic computing device to: identify a plurality of members of a group at a location; identify a missing member of the group based on one or more missing member conditions; compute a relevancy level for the missing member for an item associated with the location; responsive to computing a relevancy level above a predetermined threshold, generate a notification for the plurality of members of the group at the location, wherein the notification contains information pertaining to the missing member; and send the notification to a first mobile device associated with a member from the plurality of members of the group at the location.

### BRIEF DESCRIPTION OF THE DRAWINGS

Features of the disclosed embodiments will be more readily understood from the following detailed description of the various aspects of the invention taken in conjunction with the accompanying drawings.

FIG. 1 shows an exemplary venue.

FIG. 2 is a block diagram of an environment for a system in accordance with embodiments of the present invention.

FIG. 3 is a block diagram of an example of a mobile device used in embodiments of the present invention.

FIG. 4 illustrates a full group.

FIG. 5 illustrates a group with a missing member.

FIG. 6 illustrates an exemplary notification to a mobile device associated with a member from the group at the venue.

FIG. 7A illustrates an exemplary notification to a mobile device associated with a missing member from the group.

FIG. 7B illustrates an exemplary purchase opportunity notification to a mobile device associated with a missing member from the group.

FIG. 8 illustrates exemplary data tables used in embodiments of the present invention.

FIG. 9 is a flowchart indicating process steps for embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

Disclosed embodiments provide techniques for presenting a marketing notification for a missing member of a group. People often shop in groups, such as groups of family, friends, coworkers, and the like. Disclosed embodiments detect the presence of a group in a location such as a retail venue. In scenarios where at least one member of the group is absent at the location, the group members that are present at the location receive a marketing message pertaining to the missing member, such as a suggestion to purchase a gift for the missing member. In this way, disclosed embodiments provide marketing opportunities to influence shoppers by reminding them about their missing peer.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

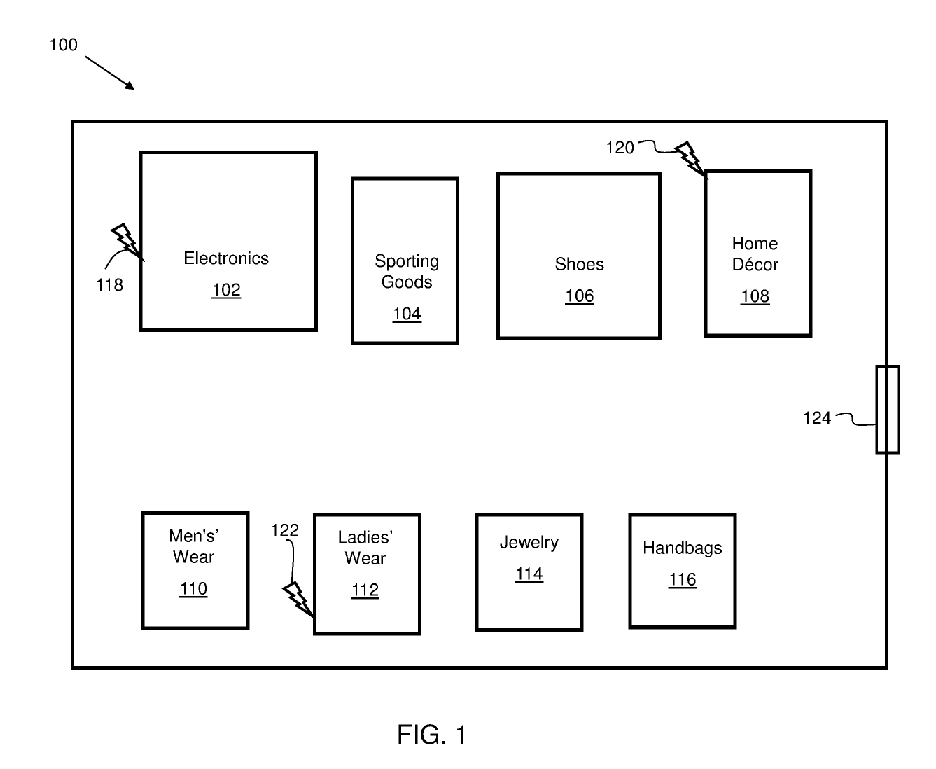

FIG. 1 shows an exemplary venue 100, Typically, the venue is an indoor venue such as a retail establishment. Venue 100 is a department store including various departments indicated by reference numbers 102-116. An Indoor Positioning System (IPS) allows a mobile device to determine its position within the venue. In embodiments, multiple wireless transmitters 118, 120, and 122 are positioned within venue 100. The wireless transmitters may be RF beacons, WiFi transmitters, Bluetooth® transmitters, or other suitable protocol. When a user enters the store at entrance 124, their mobile device makes a location assessment within the venue by use of the wireless transmitters. The location assessment may be accomplished by triangulation, beacon proximity, or other suitable location determination technique. In some embodiments, triangulation may occur using transmitters that are located outside of the venue. For example, in some embodiments, triangulation may occur using local radio station transmitters that are within range of the venue, such as local FM or AM radio stations. Embodiments may include assessing signal strength and additionally performing a station identification using frequency and/or an SSID (service set identifier) or other identifier to make a location assessment. In some embodiments, an inertial navigation system may be used to determine location within the venue 100. In some embodiments, an optical system may be used to determine location within the venue 100. Thus, in some embodiments, a location assessment may be made without the use of transmitters. Regardless of how the location determination is made, it is desirable for retailers to know the habits and preferences of their customers. For example, it may be desirable to know that a particular customer or group of customers visited Ladies' Wear 112, followed by Handbags 116, followed by Shoes 106. By understanding the habits and preferences of individual customers, custom-tailored messages and coupons can be offered to those customers that are likely to be relevant for them. Note that while venue 100 is a retail establishment, embodiments of the present invention may be utilized in other venues such as hospitals, airports, train stations, and office buildings, to name a few. While typically the venue may be an indoor venue, embodiments may also include venues that are outdoors, or partially outdoors, such as a hotel resort.

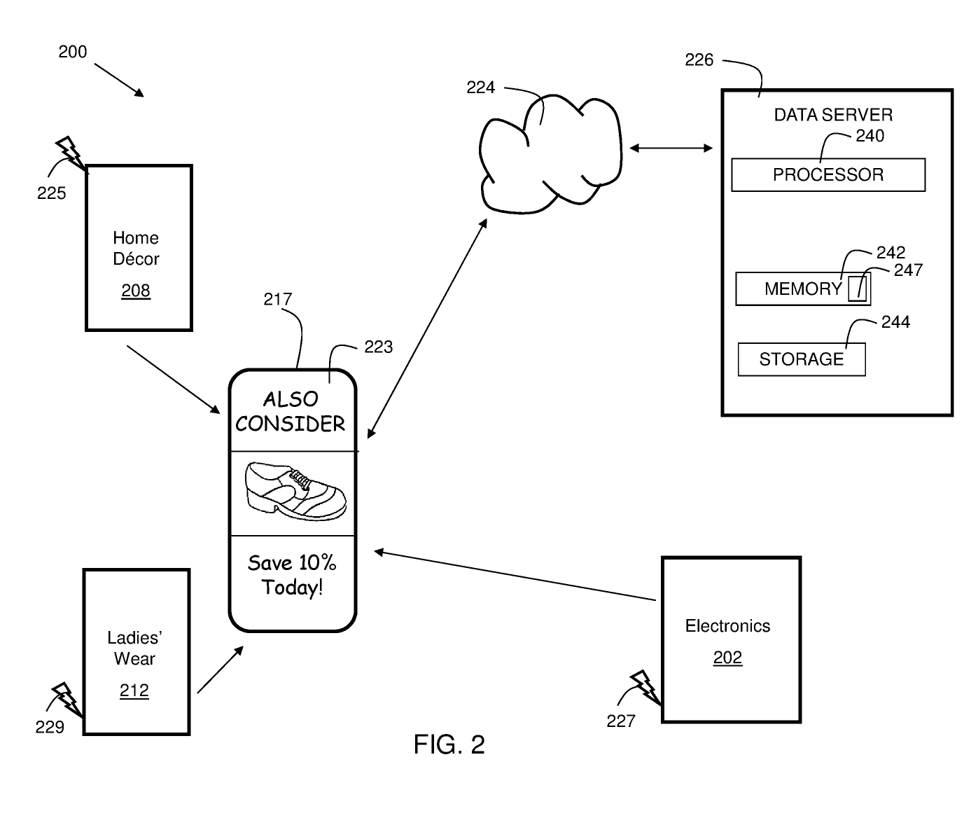

FIG. 2 is a block diagram 200 of an environment for a system in accordance with embodiments of the present invention. A user brings a mobile device 217 into a venue where it receives wireless signals from transmitters 225, 227, and 229 to make a location determination. The location determination may be a zone-based determination. For example, it may be sufficient to know that the user is in the Ladies' Wear department 212, Home Décor department 208, or Electronics department 202. It may not be necessary to resolve the location to a precise location beyond that zone determination. The mobile device 217 communicates via network 224 to a data server 226. The data server 226 may include a processor 240, memory 242, and storage 244. The processor 240 is coupled to the memory 242 such that it can access instructions 247 stored in memory 242. The processor 240 executes the instructions 247 in implementation of embodiments of the present invention. The storage 244 may include one or more hard disks, or other suitable storage technology. Note that while one data server is illustrated in diagram 200, in practice, there may be multiple data servers 226 operating in a distributed manner for load balancing and data redundancy. In embodiments, data servers 226 may implement an object store system utilizing a cloud-based architecture.

The mobile device 217 transmits location information via network 224 to the data server 226. The location information may include a zone and a user identifier. For example, the zone may indicate that the user is in the Ladies' Wear department 212. The data server 226 may maintain a customer profile and have preferences stored for the customer, which indicates that the customer also tends to visit the shoe department when they visit the venue. The data server 226 can in response serve a shoe department coupon and/or alert message 223 to the user's mobile device 217. This can be performed using customized applications (“apps”) running on the mobile device. In embodiments, users install the app, and opt in to provide their location information in exchange for coupons, discounts, and other product-related information. Thus, a more interactive shopping experience is achieved. In some embodiments, the location information may further include path information, such that the path the user took within the venue is included as part of the location information.

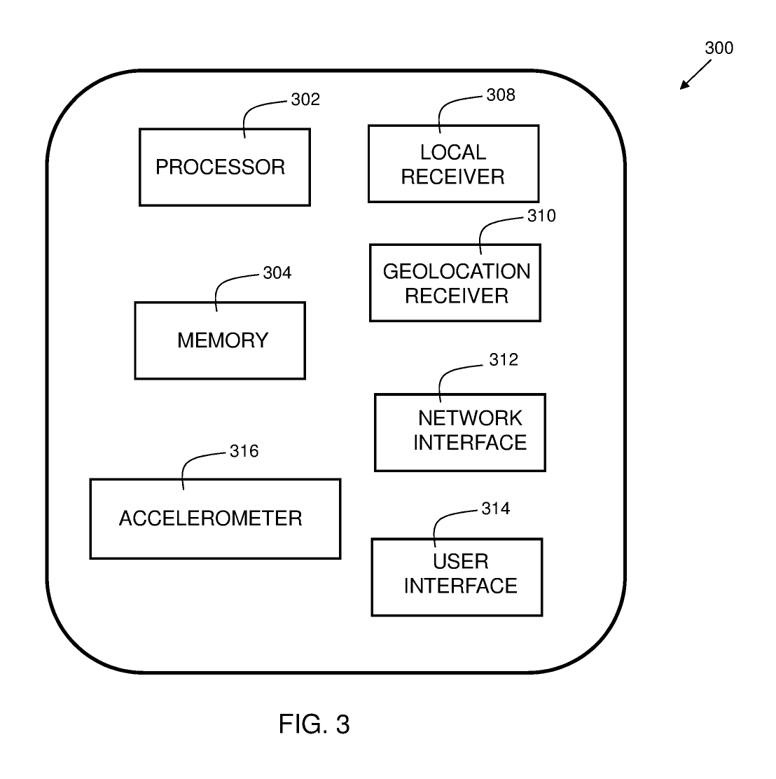

FIG. 3 is a block diagram of an example of a mobile device 300 used in embodiments of the present invention. The mobile device 300 includes a processor 302 which is coupled to memory 304. Memory 304 contains instructions, that when executed by the processor 302, perform the various methods in accordance with illustrative embodiments. Mobile device 300 may further include a local receiver 308. The local receiver 308 includes a receiver for local radio frequency (RF) signals. In embodiments, the local receiver may include a Bluetooth® receiver, ZigBee® receiver, or other near field communication (NFC) receiver. Mobile device 300 further may include a geolocation receiver 310. The geolocation receiver may be configured to receive signals from multiple satellites to triangulate a position on Earth. In embodiments, the geolocation receiver 310 includes a Global Positioning System (GPS) receiver, GLONASS receiver, Galileo receiver, or other satellite-based positioning system. The mobile device 300 further includes a network interface 312. Network interface 312 may include a cellular network interface, a WiFi interface, such as an IEEE 802.11 interface, or other suitable network interface. Mobile device 300 may further include a user interface 314. User interface 314 may include a touchscreen, and provides a user with the ability to enter information as necessary to utilize embodiments of the present invention. The mobile device 300 may further include an accelerometer 316 which may be used to detect motion of the mobile device, and may serve in the role of location assessment using inertial navigation techniques. In some embodiments, mobile device 300 may be a smart phone or tablet computer.

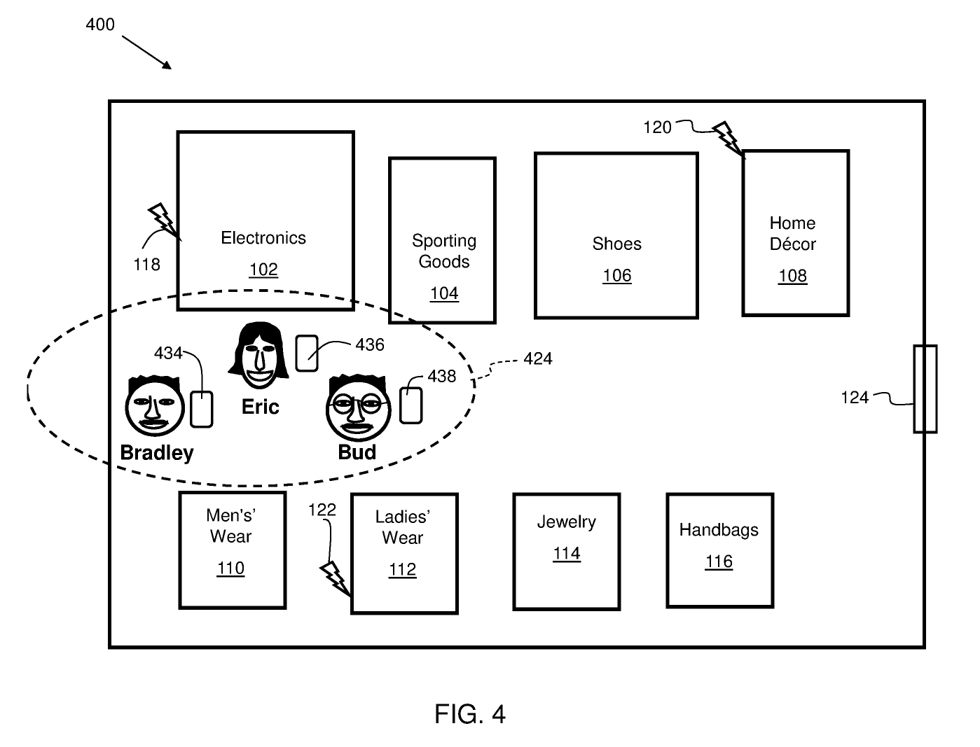

FIG. 4 illustrates a full group inside the venue 400. A group comprises a plurality of members (i.e., at least two). Venue 400 is substantially similar to venue 100. In embodiments, a plurality of members of a group at a location are identified. In the example, three members of a group 424 are identified: Bradley with electronic device 434, Eric with electronic device 436, and Bud with electronic device 438. In embodiments, the electronic devices may be smartphones. In embodiments, a group may be formed according to any suitable process.

Groups may be entered manually to the system 226 (FIG. 2) by a user associating members' electronic devices with a particular group or groups. The system may provide a user interface that a user can access via client device 217 (FIG. 2) to enter the pertinent information. On the client device, the user may be prompted to open an account with a username and password to access the user interface.

Groups may be generated based on social media data. On social networking websites, a user typically registers for a user account with the site, and can connect his/her account with one or more groups of other users by “following”, “friending”, etc. The group data may be imported to the system, or scraped by the system 226 (FIG. 2). The data may be analyzed to determine of what groups a user is a member, and who the other group members are.

Groups can be generated as inferred from facial recognition processing of images from surveillance cameras in the venue. Facial recognition processes may compare the detected faces with profile images from social media or other similar sites to determine the identities of the persons. When the faces are detected within a predetermined proximity, it can be inferred that the faces are of people in a group (i.e., the people are travelling together). In facial recognition processes, an image or video may be analyzed. Edge detection, gradient processing, and other processes may be used to match features of a face in the image with a known face from a database, social media website, or other repository. In other embodiments, the camera of a mobile device associated with a user may be used to identify nearby faces and determine the existence of a group at a given location.

Groups can be generated as inferred from historical data based on detected electronic devices in close proximity. When two or more user devices are determined to be within a close range of one another (i.e., under a predetermined threshold distance), for at least a predetermined period of time, and/or at least a predetermined number of times, then the system may associate those user devices as a group. They can be determined based on data from transmitters (beacons) 118, 120, and 122, or other suitable system.

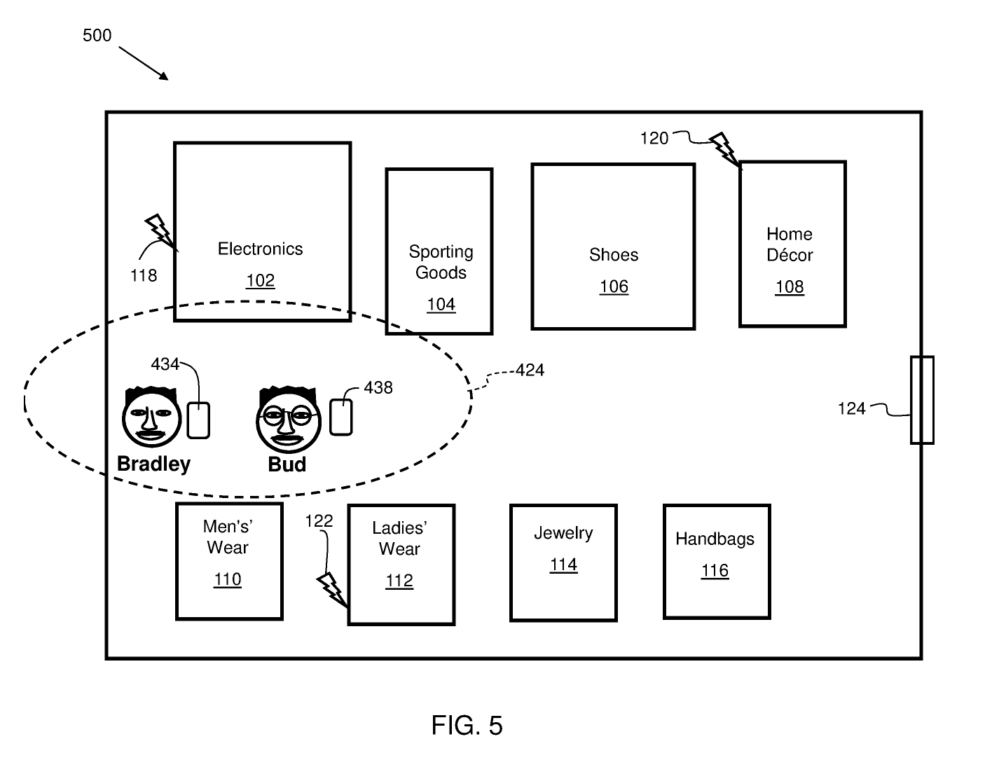

FIG. 5 illustrates the group 424 inside the venue 500 with a missing member. Venue 500 is substantially similar to venue 100. In embodiments, a missing member of the group is identified based on one or more missing member conditions. The one or more missing member conditions can be based on the detection of electronic devices of users, facial recognition, or other suitable method.

In some embodiments, the one or more missing member conditions includes detecting an absence of a second electronic computing device at the location, wherein the absent electronic device is associated with the missing member. Electronic device 434 of Bradley and electronic device 438 of Bud are present in the venue, but user device 436 of Eric is identified as missing/absent. Thus, a missing member condition is triggered. The determination that a group is present with a missing member can be made based on data from beacons 118, 120, and 122, or other suitable system.

In some embodiments, the one or more missing member conditions includes detecting the absence of the second electronic device for a predetermined duration. For example, the predetermined duration may be a period of two weeks. When Eric's electronic device 436 hasn't been detected in the venue in two weeks, a missing member condition is triggered. <<PARA>> In some embodiments, the one or more missing member conditions includes detecting the absence of the second electronic computing device for a predetermined number of visits of the plurality of members of the group at the location. For example, the predetermined number of visits may be three. When Eric's electronic device 436 has not been detected in the venue the last three times that Bud's electronic device 438 and Bradley's electronic device 434 were detected in the venue together, a missing member condition is triggered.

In embodiments, the one or more missing member conditions includes detecting the faces of a plurality of group members at a location with at least one member's face missing. The system may analyze, using facial recognition processes, images and footage from security cameras in the venue to collect such data.

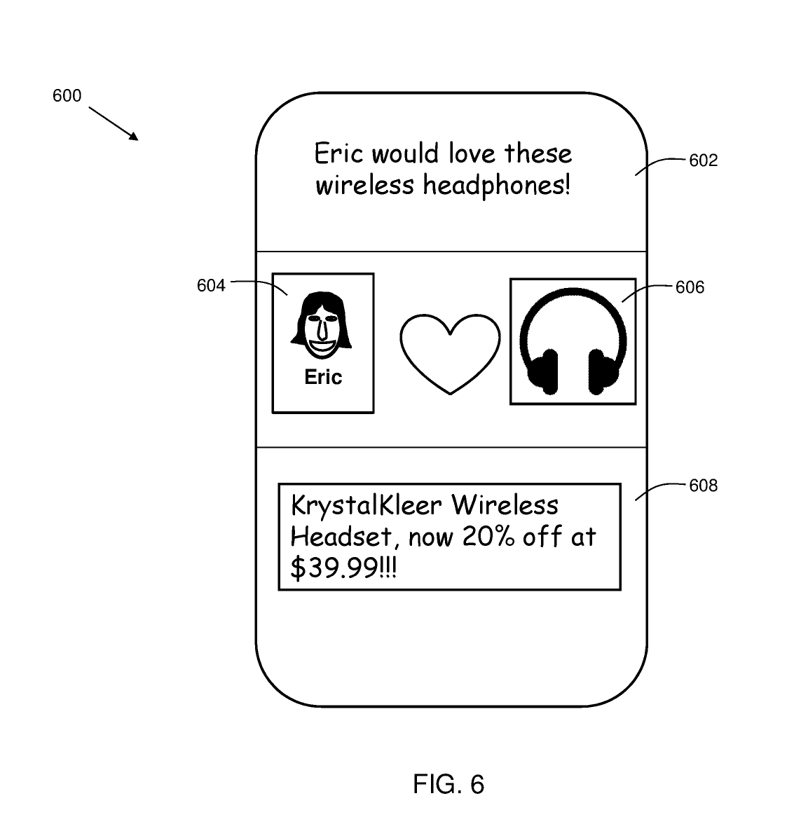

FIG. 6 illustrates an exemplary notification 600 to a mobile device associated with a member from the group at the venue. In embodiments, a relevancy level is computed for the missing member for an item associated with the location. In embodiments, the relevancy level may be determined based on whether a keyword, relating to an item within a predetermined distance from a group having a missing member, is stored in association with the account of the missing member. The relevancy level is compared to a predetermined threshold. In embodiments, the relevancy level can be based on interests, or on some other factors that might cause an advertisement to be targeted to a user. These factors can include, but are not limited to, recent browser history, social media activity, ecommerce system activity, and/or proximity to a calendar date (e.g., birthday, anniversary, etc.).

Responsive to computing a relevancy level above the predetermined threshold, a notification is generated for the plurality of members of the group at the location. In the example, the predetermined distance is less than or equal to 35 feet. This means an item must be less than or equal to 35 feet from the plurality of members of the group at the location in order to be included in a notification. In the example, a threshold for a relevancy level to trigger generation of a notification is greater than or equal to 1. This means that at least one keyword in the data stored in the missing member's user account must match a keyword relating to the item within the predetermined threshold.

In the example, headphones (an item) are identified as detected within 30 feet of electronic devices 434, 438 of a plurality of members of group 424 (with Eric's electronic device 436 missing) (i.e., less than 35 feet from the group members). “Music” and “audiobooks” are stored in Eric's user account as hobbies/interests of his. Since music and audiobooks are two keywords relating to the keyword of “headphones” (as determined by a comparison to a dictionary, database, or other suitable repository), the interest score is a 2, which is greater than 1. Accordingly, this triggers a notification to be generated.

In embodiments, a notification 600 is generated for at least one member of the group at the location. The notification 600 may include content suggesting the user buy the identified item as a gift to the missing member. The notification can be rendered on an electronic display of a mobile device. The notification may contain information pertaining to the missing member and the identified item. The notification 600 may include a gift suggestion message, which may include the suggestion. In the example, gift suggestion message 602 recites: “Eric would love these wireless headphones!” The notification 600 may include graphics, such as an image of the missing member and an image of the suggested item. In the example, the graphics include an image 604 of Eric (extracted from his user account), a heart, and an image 606 of the headphones (extracted from a website or store account, etc.). The notification 600 may further include a coupon or offer relating to the suggested item. The notification 600 is sent to a first electronic device 434 of at least one member of the group. In some embodiments, the notification 600 is sent to the electronic devices 434, 438 of the plurality of group members at the location. In the example, the offer 608 recites: “KrystalKlear Wireless Headset, now 20% off at $39.99!!!” In embodiments, the notification 600 may include more, fewer, or different elements. All suitable implementations are included within the scope of the invention. In embodiments, a gift suggestion message can include a product description for a product spatially located within a predetermined proximity from the first electronic computing device (i.e., at the retail venue).

Notification 600 is an example. In some embodiments, more or fewer elements may be included on the notification. Any suitable configuration is included within the scope of the invention,

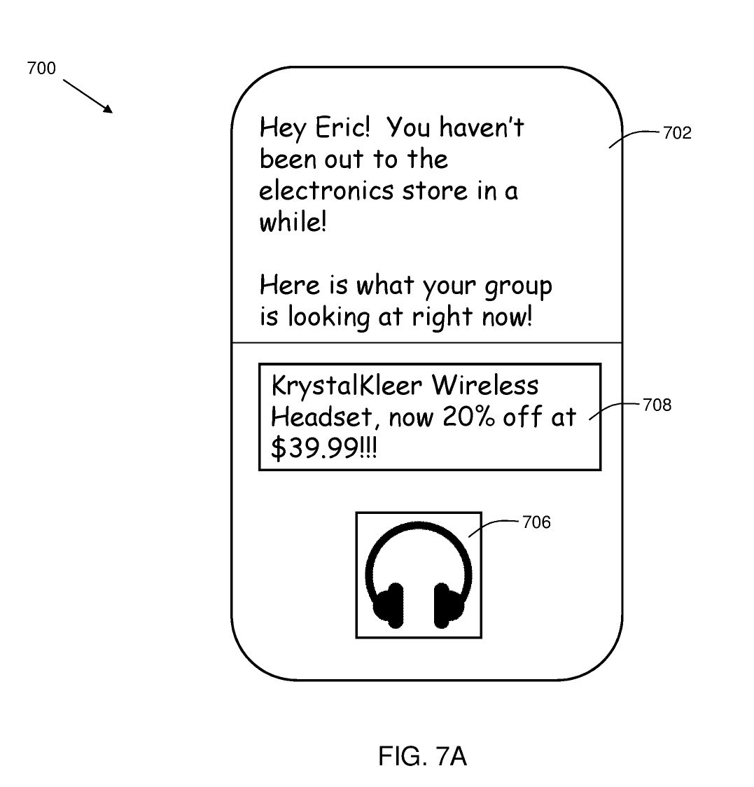

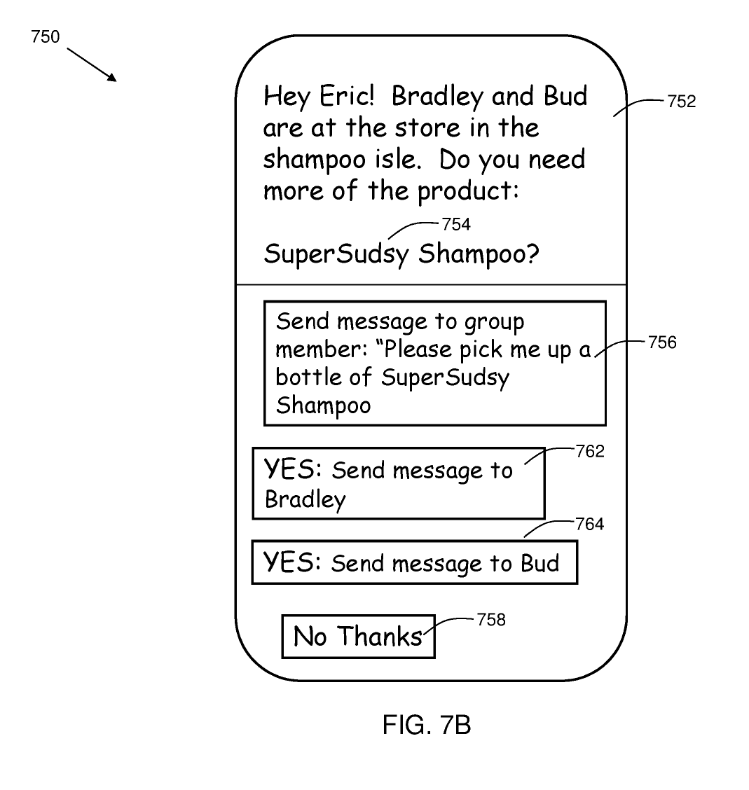

FIG. 7A illustrates an exemplary notification 700 rendered on an electronic display of a mobile device associated with a missing member from the group. Embodiments may include sending a second notification to a second electronic device that is associated with the missing member. In embodiments, the second notification 700 may include a message 702 referring to the identified item. In the example, the message 702 recites: “Hey Eric! You haven't been out to the electronics store in a while! Here is what your group is looking at right now!” The second notification may include an offer 708, which in the example, recites: “KrystalKlear Wireless Headset, now 20% off at $39.99!!!” The second notification 700 may include an image 706 of the item, which in the example is a photo of the suggested headphones. In embodiments, the notification 700 may include more, fewer, or different elements. All suitable implementations are included within the scope of the invention. In embodiments, the second notification can include a product description for a product spatially located within a predetermined proximity from the electronic computing device associated with the member from the plurality of members of the group at the location (i.e., at the retail venue).

FIG. 7B illustrates an example 750 showing a purchase opportunity notification 752 rendered on an electronic display of a mobile device associated with a missing member from the group. In this embodiment, the missing member is provided with a convenient mechanism for requesting the members of the group that are present to purchase or otherwise acquire an item of interest. The purchase opportunity notification 752 includes a product 754 for which the missing member is given the opportunity to request. Field 756 is a YES button that when activated by the user (e.g., pressed, clicked, or otherwise selected) causes a computer generated message to be sent to the other group members. In this way, the group members that are at the given retail location can be conveniently prompted to pick up a product on behalf of the missing member. In embodiments, the user can select a specific group member to be messaged to retrieve the associated product 754. In this example, the user can press, select, or otherwise activate field 762 to request Bradley to retrieve/obtain the product. Alternatively, the user can press, select, or otherwise activate field 764 to request Bud to retrieve/obtain the product. If the user does not wish to have the group obtain the product for him, he can instead activate field 758 by pressing, clicking, or otherwise selecting that field, in which case no request is sent to the other group members. Thus, embodiments can include generating and transmitting a purchase opportunity notification.

Notifications 700 and 752 are examples. In some embodiments, more or fewer elements may be included on the notifications. Any suitable configuration is included within the scope of the invention.

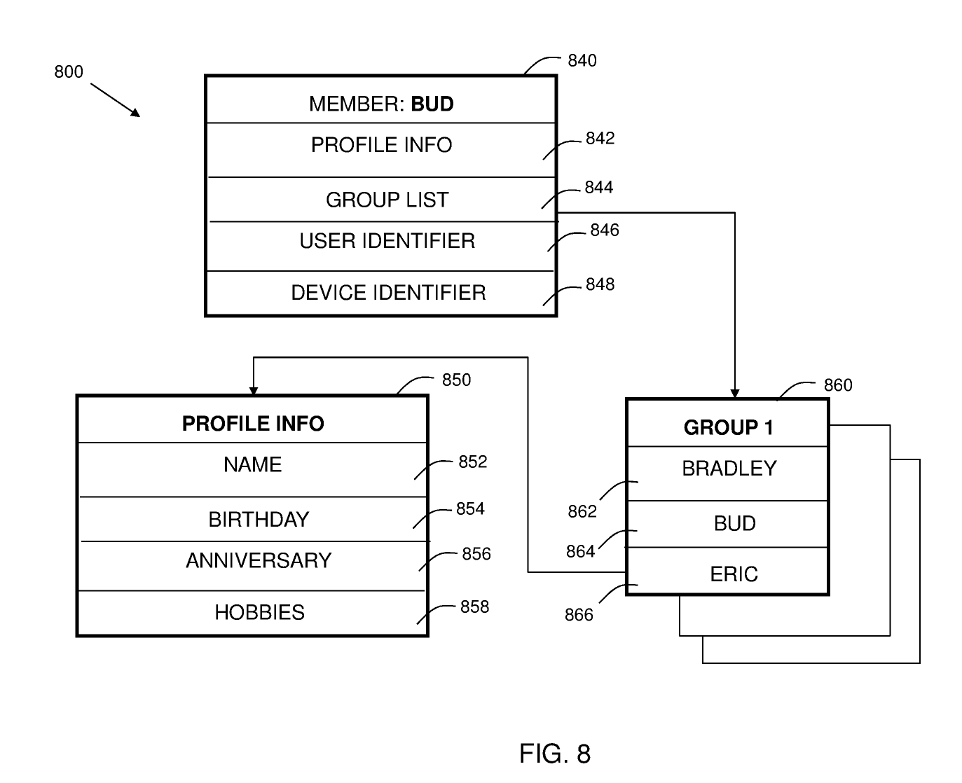

FIG. 8 illustrates an example 800 of data tables used in embodiments of the present invention. Example tables 840, 850, and 860 are shown with their respective data therein. These tables may reside in the data server 226 (FIG. 2) or other network-connected database. The database may be a relational database accessible thru SQL. The database may be hierarchical. The database may be of any suitable format. In some embodiments, multiple databases may be provided to store the data and various tables.

Table 840 stores information relating to a system user: Member: Bud. It includes data such as Profile Info 842, Group List 844, User Identifier 846, and Device Identifier 848. Device Identifier 848 may be an Ethernet MAC address, a Bluetooth address, or a UUID (from a Bluetooth Low Energy beacon), etc. The electronic device may be a smartphone, a wearable fitness monitor, a tablet computer, or other suitable device. In embodiments, a least one table may be provided for each system user.

Table 860 stores information relating to a group: Group 1. It includes data such as the names of the group members Bradley 862, Bud 864, and Eric 866. The names may be determined from analysis of electronic devices associated with the members of the group. In embodiments, a least one table may be provided for each group.

Table 850 stores information relating to Profile Info. It includes data such as Name 852, Birthday 854, Anniversary 856, and Hobbies 858. In embodiments, at least one table may be provided for each profile. The profile information may be collected via a retailer software application (an “app.”). When a user installs the retailer app., s/he consents to being tracked, for example, via checking a box or clicking a radio button. S/he also provides information, such as on her address (i.e., location), hobbies, likes, preferred brands, etc. An option may be presented to obtain consent from the user to scrape social media posts for more information. In exchange for allowing this information to be harvested, the user will get special offers and coupons pushed to his/her electronic device. At least some of these offers will be based on relevancy levels computed for various items near which other members of the user's group are located when the user is absent.

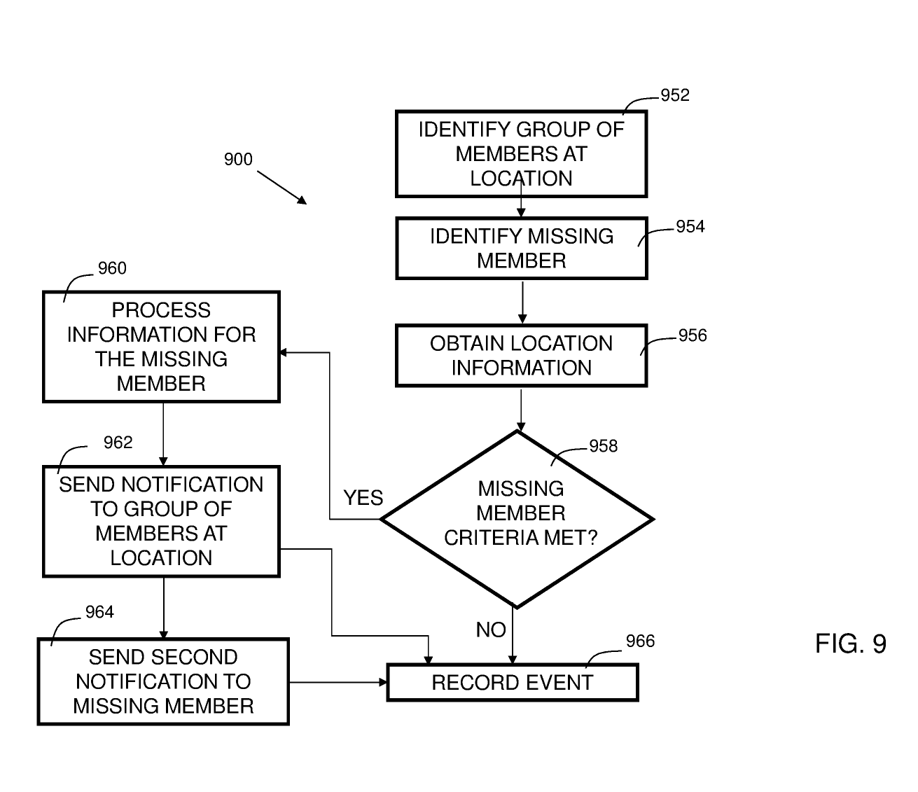

FIG. 9 is a flowchart 900 indicating process steps for embodiments of the present invention. At 952, a plurality of members of the group at a location are identified. At 954, a missing member of the group is identified based on one or more missing member conditions. At 956, location information is identified. At 958, it is determined whether missing member criteria is met. If no, at 966, the event is recorded. Alternatively, if yes, at 960, information is processed for the missing member. This may include computing a relevancy level for the missing member for an item associated with the location. Responsive to computing a relevancy level above a predetermined threshold, at 962, a notification is generated for the plurality of members of the group at the location. The notification contains information pertaining to the missing member. The notification is sent to a first electronic computing device associated with a member from the plurality of members of the group at the location. Optionally, at 964, a second notification is sent to the missing member. At 966, the event is recorded. In some embodiments, more or fewer elements may be included in the process. Any suitable configuration is included within the scope of the invention.

As can now be appreciated, disclosed embodiments provide techniques for presenting a marketing notification for a missing member of a group. For example, an opportune time to purchase a gift for someone is when that person is not with the shopper. Disclosed embodiments serve to remind the shopper about the person who is currently not there, and can make gift suggestions based on products in proximity to the shopper, thereby enhancing retail marketing capabilities.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

What is claimed is:

1. A computer-implemented method of sending a notification pertaining to a missing member of a group, the method comprising:
identifying a plurality of members of the group at a location;
identifying a missing member of the group based on one or more missing member conditions;
computing a relevancy level for the missing member for an item associated with the location;
responsive to computing a relevancy level above a predetermined threshold, generating a notification for the plurality of members of the group at the location, wherein the notification contains information pertaining to the missing member; and
sending the notification to a first electronic computing device associated with a member from the plurality of members of the group at the location.

2. The method of claim 1, wherein the one or more missing member conditions includes detecting an absence of a second electronic computing device at the location, wherein the electronic device is associated with the missing member.

3. The method of claim 2, wherein the one or more missing member conditions includes detecting the absence of the second electronic device for a predetermined duration.

4. The method of claim 2, wherein the one or more missing member conditions includes detecting the absence of the second electronic computing device for a predetermined number of visits of the plurality of members of the group at the location.

5. The method of claim 1, wherein generating a notification for the plurality of members of the group at the location comprises generating a gift suggestion message.

6. The method of claim 5, wherein the gift suggestion message includes a product description for a product spatially located within a predetermined proximity from the first electronic computing device.

7. The method of claim 1, further comprising sending a second notification to a second electronic computing device that is associated with the missing member.

8. The method of claim 7, wherein the second notification includes a product description for a product spatially located within a predetermined proximity from the electronic computing device associated with the member from the plurality of members of the group at the location.

9. An electronic communication device comprising:
a processor;
a memory coupled to the processor, the memory containing instructions, that when executed by the processor, perform the steps of:
identifying a plurality of members of a group at a location;
identifying a missing member of the group based on one or more missing member conditions;
computing a relevancy level for the missing member for an item associated with the location;
responsive to computing a relevancy level above a predetermined threshold, generating a notification for the plurality of members of the group at the location, wherein the notification contains information pertaining to the missing member; and
sending the notification to a first mobile device associated with a member from the plurality of members of the group at the location.

10. The electronic communication device of claim 9, wherein the memory further comprises instructions, that when executed by the processor, perform the step of detecting an absence of a second mobile device at the location, wherein the electronic device is associated with the missing member.

11. The electronic communication device of claim 10, wherein the memory further comprises instructions, that when executed by the processor, perform the step of detecting the absence of the second mobile device for a predetermined duration.

12. The electronic communication device of claim 10, wherein the memory further comprises instructions, that when executed by the processor, perform the step of detecting the absence of the second mobile device for a predetermined number of visits of the plurality of members of the group at the location.

13. The electronic communication device of claim 9, wherein the memory further comprises instructions, that when executed by the processor, perform the step of generating a notification that includes a gift suggestion message for the plurality of members of the group at the location.

14. The electronic communication device of claim 13, wherein the memory further comprises instructions, that when executed by the processor, perform the step of generating the gift suggestion message including a product description for a product spatially located within a predetermined proximity from the first mobile device.

15. The electronic communication device of claim 9, wherein the memory further comprises instructions, that when executed by the processor, perform the step of sending a second notification to a second mobile device.

16. A computer program product for sending a notification pertaining to a missing member of a group, for an electronic computing device comprising a computer readable storage medium having program instructions embodied therewith, the program instructions executable by a processor to cause the electronic computing device to:
identify a plurality of members of a group at a location;
identify a missing member of the group based on one or more missing member conditions;
compute a relevancy level for the missing member for an item associated with the location;
responsive to computing a relevancy level above a predetermined threshold, generate a notification for the plurality of members of the group at the location, wherein the notification contains information pertaining to the missing member; and
send the notification to a first mobile device associated with a member from the plurality of members of the group at the location.

17. The computer program product of claim 16, further comprising program instructions executable by a processor to cause the electronic computing device to generate a notification that includes a gift suggestion message for the plurality of members of the group at the location.

18. The computer program product of claim 17, further comprising program instructions executable by a processor to cause the electronic computing device to include in the gift suggestion message, a product description for a product spatially located within a predetermined proximity from the first mobile device.

19. The computer program product of claim 16, further comprising program instructions executable by a processor to cause the electronic computing device to send a second notification to a second mobile device.

20. The computer program product of claim 19, further comprising program instructions executable by a processor to cause the electronic computing device to include in the second notification, a product description for a product spatially located within a predetermined proximity from the first mobile device.
